(19) United States
(12) Patent Application Publication
(10) Pub. No.: US 2016/0150397 A1
(43) Pub. Date: May 26, 2016

(54) SYSTEM AND METHOD FOR IDENTIFYING A USER OF A MOBILE COMPUTERIZED DEVICE

(71) Applicants: Hyundai America Technical Center, Inc., Superior Township, MI (US); Hyundai Motor Company, Seoul (KR); Kia Motors Corporation, Seoul (KR)

(72) Inventor: Allan Lewis, Windsor (CA)

(21) Appl. No.: 14/549,279

(22) Filed: Nov. 20, 2014

(51) Int. Cl. H04W 8/22; G06F 3/044

(52) U.S. Cl. CPC H04W 8/22; G06F 3/044

(57) ABSTRACT

The present disclosure provides, in some aspects, a system for identifying a user of a mobile computerized device. The system includes an electrode configured to be in selective electrical communication with a driver of a vehicle when the driver of the vehicle is driving the vehicle, a signal generator electrically connected to the electrode and configured to selectively output an identification signal to the electrode when the vehicle is in a predetermined mode of operation, wherein the identification signal is configured to travel through the driver and into a human-machine interface (HMI) of a mobile computerized device.

### BACKGROUND

(a) Field of the Invention

This disclosure relates to electrical mobile computerized devices, more specifically to electrical mobile computerized devices in vehicles.

(b) Description of the Related Art

Distracted driving is a safety concern as more advanced mobile technologies are available to the driver while the driving a vehicle. For example, texting or otherwise using a cell phone (e.g., a smart phone) while driving a vehicle can be both dangerous and illegal. However, such technologies entice operators of vehicles to engage with the distracting technologies while driving.

To improve safety in passenger cars, for example, many vehicles with touch screen technology disable the use of one or more functions of the mobile computerized device when the vehicle is in motion or even when the transmission is in drive. However, such built in systems cannot address the distraction of using mobile technologies. Improved anti-distraction technologies are needed.

The above information disclosed in this Background section is only for enhancement of understanding of the background of the invention and therefore it may contain information that does not form the prior art that is already known in this country to a person of ordinary skill in the art.

### SUMMARY

The present disclosure provides, in some aspects, a system for identifying a user of a mobile computerized device. The system includes an electrode configured to be in selective electrical communication with a driver of a vehicle when the driver of the vehicle is driving the vehicle, a signal generator electrically connected to the electrode and configured to selectively output an identification signal to the electrode when the vehicle is in a predetermined mode of operation, wherein the identification signal is configured to travel through the driver and into a human-machine interface (HMI) of a mobile computerized device.

Suitable mobile computerized devices can include an identification module operatively connected to the HMI and configured to receive the identification signal such that, when a driver touches the HMI during the predetermined mode of operation, the identification module receives the identification signal and determines that the driver is attempting to operate the HMI during the predetermined mode of operation, wherein when the identification module determines that the driver of the vehicle is attempting to operate the HMI during the predetermined mode of operation, a function of the mobile computerized device is at least partially disabled.

The electrode may be disposed on or within at least one of a steering wheel and/or driver seat of the vehicle. The driver seat may include a seat portion and a back portion. The electrode may be disposed on at least one of the seat portion, the back portion, an armrest of the driver seat, or a head rest of the driver seat.

The system can further include at least one additional electrode electrically connected to the signal generator and disposed on the driver seat to be in selective electrical communication with the driver. The electrode may be disposed on the seat portion and the at least one additional electrode may be disposed on the back portion.

The identification signal may include an analog modulated signal. The identification signal can include a digitally encoded signal.

The HMI may include a capacitive touch screen configured to provide touch controllability to the HMI. The function that can be at least partially disabled may be touch controllability of the capacitive touch screen.

The predetermined mode of operation of the vehicle may include at least one of when the vehicle is in gear, when the vehicle is in motion, or when an engine of the vehicle is on.

In accordance with at least one aspect of this disclosure, a method for preventing a driver of a vehicle from operating a mobile computerized device therein while the vehicle is in a predetermined mode of operation includes determining if the vehicle is in a predetermined mode of operation and sending an identification signal to an electrode disposed in a seat of the vehicle when the vehicle is in the predetermined mode of operation such that the identification signal can transmit through a human-machine interface (HMI) of the mobile computerized device to an identification module of the mobile computerized device and the mobile computerized device can determine whether the driver is attempting to operate the HMI in the predetermined mode of operation.

The method may further include receiving an operational mode signal indicative of a present mode of operation of the vehicle from a vehicle computer. The method can further include passing the identification signal into and/or through the driver.

In accordance with at least one aspect of this disclosure, a non-transitory computer readable medium can include a computer executable method, the method including, receiving an identification signal through a human-machine interface (HMI) of a mobile computerized at an identification module of the mobile computerized device, determining whether a driver of a vehicle is attempting to operate the HMI in a predetermined mode of operation, and at least partially disabling a function of the HMI if it is determined that the driver is attempting to operate the HMI while the vehicle is in the predetermined mode of operation.

At least partially disabling a function of the HMI can include disabling a touch screen. At least partially disabling a function of the HMI can include disabling a portion of a touch screen. In some embodiments, at least partially disabling a function of the HMI can include disabling text messaging. At least partially disabling a function of the HMI can include disabling navigational inputs. Receiving the identification signal through the HMI may include receiving the identification signal along with a touch screen signal. Determining whether the driver is attempting to operate the HMI in the predetermined mode of operation may include filtering the identification signal from the touch screen signal.

### BRIEF DESCRIPTION OF THE DRAWINGS

FIG. 1 is a schematic side view of an embodiment of a system in accordance with this disclosure, shown applied to a vehicle seat;

FIG. 2 is a block diagram of the system of FIG. 1; and

FIG. 3 is a flow diagram of a method in accordance with this disclosure.

### DETAILED DESCRIPTION OF THE EMBODIMENTS

In the following detailed description, only certain exemplary embodiments of this disclosure have been shown and described, simply by way of illustration. As those skilled in the art would realize, the described embodiments may be modified in various different ways, all without departing from the spirit or scope of this disclosure. Accordingly, the drawings and description are to be regarded as illustrative in nature and not restrictive. Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In addition, when it is described that an element is “coupled” to another element, the element may be “directly coupled” to the other element or “electrically coupled” to the other element through a third element.

Further, the control logic of this disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, this disclosure will be described more fully with reference to the accompanying drawings, in which exemplary embodiments of the invention are shown.

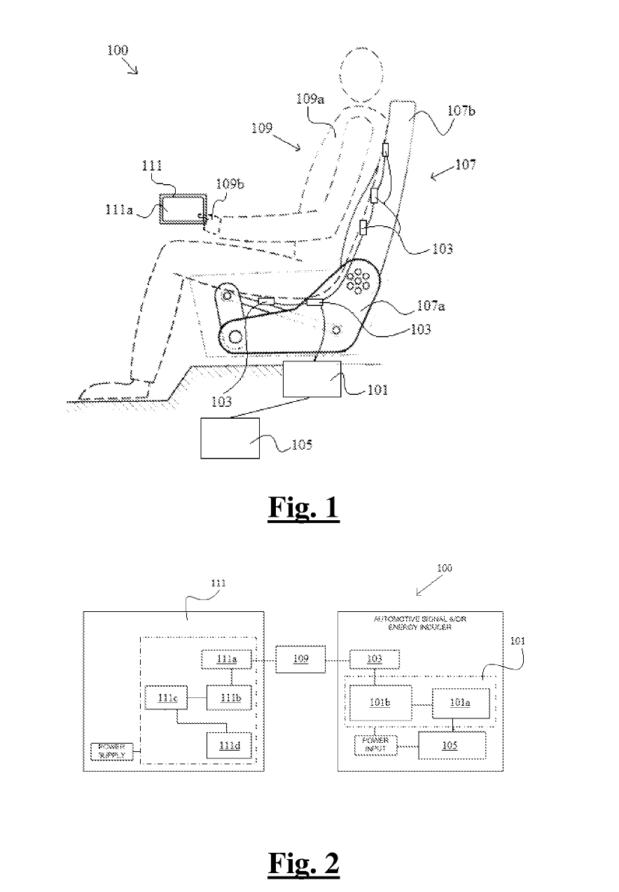

The present disclosure provides, in some aspects, a system 100 for identifying a user of a mobile computerized device 111 (e.g., a smart phone or tablet). Referring to FIGS. 1 and 2, the system 100 includes a signal generator 101 electrically connected to one or more electrodes 103 or antennas. The signal generator 101 is configured to selectively output an electrical signal (e.g., an identification signal) to the electrodes 103 when the vehicle is in a predetermined mode of operation (e.g., when the vehicle engine is on, in gear, in motion, and/or at a predetermined speed). For example, when the vehicle (e.g., a passenger car, not shown) is in drive, the signal generator 101 can output the identification signal to the electrodes 103. The identification signal that is output to the electrodes 103 is configured to travel through the driver 109 and into a human-machine interface (HMI) of a suitable mobile computerized device 111 without harming the driver 109. In some embodiments, the frequency of the identification signal is between about 500 kHz and about 3 MHz.

The HMI 111a of the mobile computerized device may include a capacitive touch screen or any other suitable touch screen configured to provide touch controllability to the HMI 111a. Alternatively or conjunctively, the HMI 111a can include any other suitable control mechanism (e.g., analog controls such as knobs and/or buttons). In the case where the HMI 111a includes analog controls, each control can include an electrode/antenna for receiving an identification signal as described herein.

The signal generator 101 can be connected to the vehicle computer 105 or other suitable information device to determine what mode of operation the vehicle is in. Referring to FIG. 2, the signal generator 101 can include a logic 101a that can receive a signal from the vehicle computer 105 that is indicative of the vehicle being engaged in gear (in drive for automatic transmission vehicles). The logic 101a can receive the signal from the vehicle computer 105 and instruct a signal modulator/encoder 101b to create the identification signal and/or send the identification signal to the electrode 103.

In some embodiments, an electrical signal may be constantly output to the electrodes 103 by a power supply of the signal generator 101, and only modulated and/or encoded when the vehicle is in the predetermined mode of operation.

The electrodes 103 are configured to be in selective electrical communication with a driver 109 of a vehicle when the driver 109 of the vehicle is driving the vehicle. For example, the electrodes 103 may be disposed on or within a driver seat 107 of the vehicle. While shown disposed in the driver seat 107, the electrodes 103 can be disposed on or in any suitable portion of the vehicle (e.g., a steering wheel) such that the electrodes 103 are in selective electrical communication with the driver 109 when the driver 109 is in the vehicles driver seat 107.

The driver seat 107 can include a seat portion 107a, a back portion 107b, and/or any other suitable portion (e.g. an armrest, a head rest). In certain embodiments, the electrodes 103 may be disposed on only one of the seat portion 107a or the back portion 107b of the driver seat 107. In other embodiments, the electrodes 103 can be disposed on both the seat portion 107a and the back portion 103 as shown in FIG. 1.

Referring to FIG. 2, the mobile computerized device 111 can further include an identification module 111b operatively connected to the HMI 111a and configured to receive the identification signal. The identification module 111a can be any suitable software and/or hardware configured to receive and/or filter inputs from the HMI 111a and to determine the existence of the identification signal (whether encoded or modulated) in the inputs from the HMI 111a (e.g., a modification of capacitance of the driver 109, an additional modulated and/or encoded signal).

In some embodiments, the identification module 111b can be operatively connected to or a part of a control system 111c which is also operatively connected to a display 111d for displaying information thereon (e.g., touch screen information). In other embodiments, the identification module 111a can be a separate circuit.

Upon receiving the identification signal, the identification module 111b can cause at least one function of the mobile computerized device 111 to be modified or disabled. For example, when the driver 109 touches the HMI 111a during a predetermined mode of operation (e.g., while the vehicle is in motion), the identification module 111b receives the identification signal through the HMI 111a and determines that the driver 109 is attempting to operate the HMI 111a during the predetermined mode of operation.

In some embodiments, after determining that the driver 109 is attempting to operate the HMI 111a in a predetermined mode of operation, the identification module 111b may then prevent inputs from the HMI 111a from reaching the control system 111c which controls the mobile computerized device 111, thereby effectively disabling use of the HMI 111a for the driver 109 only.

In some embodiments, after determining that the driver 109 is attempting to operate the HMI 111a in a predetermined mode of operation, the identification module 111b may send a notification signal to the control system 111c along with the inputs from the HMI 111a and the control system 111b can be configured to modify and/or disable one or more functions of the mobile computerized device 111. For example, in some embodiments, basic and/or non-distracting functions (e.g., answering phone calls) of the mobile computerized device 111 can continue to be enabled for use by the driver 109, whereas complicated and/or distracting functions (e.g., typing, texting, application usage, navigation, etc.) can be disabled. In other embodiments, the display 111d and/or the HMI 111a can be disabled entirely.

In certain embodiments, the control system 111c may display an image and/or message to the driver 109 on the display device 111d to indicate that the use of the HMI 111a is modified and/or disabled for the driver 109.

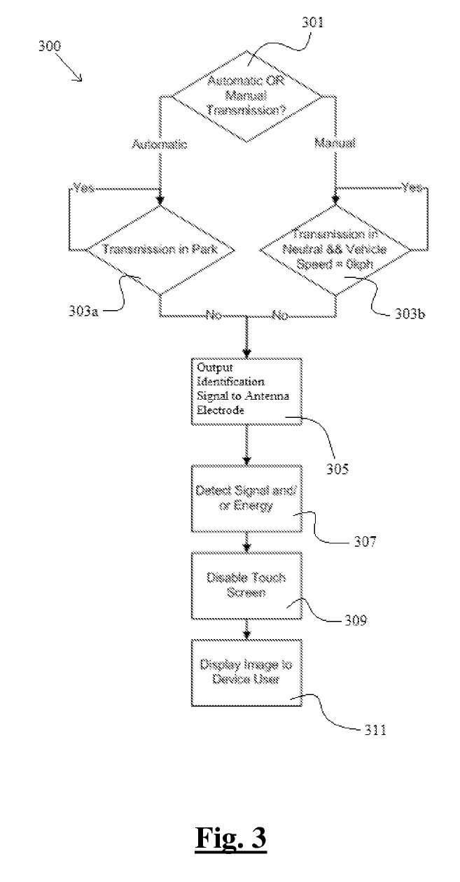

Referring additionally to FIG. 3, in accordance with at least one aspect of this disclosure, a method 300 for preventing a driver 109 of a vehicle from operating a mobile computerized device 111 therein while the vehicle is in a predetermined mode of operation may include determining if a vehicle has an automatic or manual transition (e.g., block 301). If the vehicle is an automatic transmission vehicle, it is then determined if the vehicle is in the predetermined mode of operation (e.g., if an automatic transmission is in park as in block 303a or if a manual transmission is in neutral and/or not in motion as in block 303b).

Determining whether the driver 109 is attempting to operate the HMI 111a in the predetermined mode of operation may include determining at least one of whether the vehicle is in gear, the vehicle is in motion, or an engine of the vehicle is on. The mode of operation of the vehicle can be received from the vehicle computer 105 or any other suitable source.

If the vehicle is in the predetermined mode of operation (e.g., the vehicle is on), the signal generator 105 sends an identification signal as described above to the electrodes 103. Otherwise, the loop can repeat and continue to determine if the vehicle is in the predetermined mode of operation at any suitable interval or iteration (e.g., about 100 ms).

The method 300 may also include receiving the identification signal through the HMI 111a of the mobile computerized device at an identification module 111b and detecting the identification signal (e.g., block 307). Receiving the identification signal through the HMI 111a may include receiving the identification signal along with a touch screen signal and/or filtering the identification signal from another signal.

The identification module 111b can then determine whether the driver 109 is attempting to operate the HMI 111a when the vehicle is in the predetermined mode of operation. If the identification module 111b determines this in the affirmative, the identification module 111b and/or the control system 111c can at least partially disable and/or modify a function of the HMI 111a (e.g., disabling the use of touch screen as in block 309; presenting reduced or other modified functionality).

The method 300 can also include displaying an image and/or message to the driver 109 on the display device 111d to indicate that the use of the HMI 111a is modified and/or disabled. In some embodiments, an indication as to how to comply with safe practice and/or gain additional access to the HMI 111a can be displayed.

It is contemplated that portions of the above method 300 can removed or changed in any suitable manner as would be appreciated by one skilled in the art. In accordance with at least one aspect of this disclosure, a non-transitory computer readable medium can include a computer executable method, the method including any suitable method and/or portions thereof as disclosed herein.

In accordance with at least one aspect of this disclosure, a smart phone (not shown) can include the non-transitory computer readable medium including the above described computer executable method. The smart phone may also include an identification module as described herein which can include any suitable hardware and/or software.

It is contemplated that the system disclosed herein can be applied in reverse to identify passengers in the vehicle and modify/enable the function of the mobile computerized device 111 accordingly (e.g., to affirmatively allow access to the all functions of the mobile computerized device 111 as opposed to affirmatively denying access when the vehicle is in the predetermined mode of operation).

Utilizing the systems and methods herein can allow for safe operation of vehicles by preventing distracted driving. The systems and methods herein allow for the body of the driver to be used as a reliable channel for communicating information to the mobile computerized device 111 of the vehicle (e.g., by the dielectric electromagnetic field formed outside the human body and/or by the quasi-electrostatic field passing within the human body). Also, it is contemplated that electrodes 103 in the seat 107 can function through seating material and clothing due to minute signal levels.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for identifying a user of a mobile computerized device, comprising;
an electrode configured to be in selective electrical communication with a driver of a vehicle when the driver of the vehicle is driving the vehicle;
a signal generator electrically connected to the electrode and configured to selectively output an identification signal to the electrode when the vehicle is in a predetermined mode of operation, wherein the identification signal is configured to travel through the driver and into a human-machine interface (HMI) of a mobile computerized device, wherein the mobile computerized device includes an identification module operatively connected to the HMI and configured to receive the identification signal such that, when a driver touches the HMI during the predetermined mode of operation, the identification module can receive the identification signal and determine that the driver is attempting to operate the HMI during the predetermined mode of operation, wherein when the identification module can determine that the driver of the vehicle is attempting to operate the HMI during the predetermined mode of operation, a function of the mobile computerized device is at least partially disabled.

2. The system of claim 1, wherein the electrode is disposed on or within at least one of a steering wheel and/or driver seat of the vehicle, the driver seat comprising a seat portion and a back portion.

3. The system of claim 2, wherein the electrode is disposed on at least one of the seat portion, the back portion, an armrest of the driver seat, or a head rest of the driver seat.

4. The system of claim 2, further comprising at least one additional electrode electrically connected to the signal generator and disposed on the driver seat to be in selective electrical communication with the driver.

5. The system of claim 4, wherein the electrode is disposed on the seat portion and the at least one additional electrode is disposed on the back portion.

6. The system of claim 1, wherein the identification signal includes an analog modulated signal.

7. The system of claim 1, wherein the identification signal includes a digitally encoded signal.

8. The system of claim 1, wherein the HMI includes a capacitive touch screen configured to provide touch controllability to the HMI.

9. The system of claim 8, wherein the function that is at least partially disabled is touch controllability of the capacitive touch screen.

10. The system of claim 1, wherein the predetermined mode of operation of the vehicle includes at least one of when the vehicle is in gear, when the vehicle is in motion, or when an engine of the vehicle is on.

11. A method for preventing a driver of a vehicle from operating a mobile computerized device therein while the vehicle is in a predetermined mode of operation, comprising:
determining if the vehicle is in a predetermined mode of operation; and
sending an identification signal to an electrode disposed in a seat of the vehicle when the vehicle is in the predetermined mode of operation such that the identification signal can transmit through a human-machine interface (HMI) of the mobile computerized device to an identification module of the mobile computerized device and the mobile computerized device can determine whether the driver is attempting to operate the HMI in the predetermined mode of operation.

12. The method of claim 11, further including receiving an operational mode signal indicative of a present mode of operation of the vehicle from a vehicle computer.

13. The method of claim 11, further including passing the identification signal into and/or through the driver.

14. A non-transitory computer readable medium including a computer executable method, the method comprising:
receiving an identification signal through a human-machine interface (HMI) of a mobile computerized at an identification module of the mobile computerized device;
determining whether a driver of a vehicle is attempting to operate the HMI in a predetermined mode of operation; and
at least partially disabling a function of the HMI if it is determined that the driver is attempting to operate the HMI while the vehicle is in the predetermined mode of operation.

15. The non-transitory computer readable medium of claim 14, wherein at least partially disabling a function of the HMI can include disabling a touch screen.

16. The non-transitory computer readable medium of claim 14, wherein at least partially disabling a function of the HMI can include disabling a portion of a touch screen.

17. The non-transitory computer readable medium of claim 14, wherein at least partially disabling a function of the HMI can include disabling text messaging inputs.

18. The non-transitory computer readable medium of claim 14, wherein at least partially disabling a function of the HMI can include disabling navigational inputs.

19. The method of claim 14, wherein receiving the identification signal through the HMI includes receiving the identification signal along with a touch screen signal.

20. The method of claim 19, wherein determining whether the driver is attempting to operate the HMI in the predetermined mode of operation includes filtering the identification signal from the touch screen signal.
